(19) United States
(12) Patent Application Publication
(10) Pub. No.: US 2014/0207454 A1
(43) Pub. Date: Jul. 24, 2014

(54) TEXT REPRODUCTION DEVICE, TEXT REPRODUCTION METHOD AND COMPUTER PROGRAM PRODUCT

(71) Applicant: KABUSHIKI KAISHA TOSHIBA, Tokyo (JP)

(72) Inventors: Kouta Nakata, Shinagawa-ku (JP); Taira Ashikawa, Kawasaki-shi (JP); Tomoo Ikeda, Ota-ku (JP); Kouji Ueno, Kawasaki-shi (JP); Osamu Nishiyama, Yokohama-shi (JP)

(73) Assignee: KABUSHIKI KAISHA TOSHIBA, Tokyo (JP)

(21) Appl. No.: 14/157,664

(22) Filed: Jan. 17, 2014

(30) Foreign Application Priority Data
Jan. 24, 2013 (JP) 2013-011221

(51) Int. Cl. G10L 15/26

(52) U.S. Cl. CPC G10L 15/26
USPC 704/235

(57) ABSTRACT

According to an embodiment, a text reproduction device includes a setting unit, an acquiring unit, an estimating unit, and a modifying unit. The setting unit is configured to set a pause position delimiting text in response to input data that is input by the user during reproduction of speech data. The acquiring unit is configured to acquire a reproduction position of the speech data being reproduced when the pause position is set. The estimating unit is configured to estimate a more accurate position corresponding to the pause position by matching the text around the pause position with the speech data around the reproduction position. The modifying unit is configured to modify the reproduction position to the estimated more accurate position in the speech data, and set the pause position so that reproduction of the speech data can be started from the modified reproduction position when the pause position is designated by the user.

### CROSS-REFERENCE TO RELATED APPLICATION

This application is based upon and claims the benefit of priority from Japanese Patent Application No. 2013-011221, filed on Jan. 24, 2013; the entire contents of which are incorporated herein by reference.

### FIELD

An embodiment described herein relates generally to a text reproduction device, a method therefor, and a computer program product therefor.

### BACKGROUND

Text reproduction devices are used for applications such as assisting the user in transcribing recorded uttered speech to text while listening to the speech (transcription work). In transcription work, the user may sometimes listen to the speech again so as to check the text obtained by the transcription.

Thus, some of such text reproduction devices add text input by the user to corresponding speech to allow reproduction (cueing) of speech with text from (to) any position.

Since, however, recorded speech contains ambient sound, noise, filler, speech errors made by a speaker, and the like, characters of text and speech cannot be precisely associated and speech cannot be accurately cued up with the text reproduction devices of the related art.

### BRIEF DESCRIPTION OF THE DRAWINGS

FIG. 1 is a diagram illustrating an example of a display screen of an information terminal 5 according to an embodiment;

FIG. 2 is a block diagram illustrating a text reproduction device 1 and the information terminal 5 according to the embodiment;

FIG. 3 is a flowchart illustrating processing performed by the text reproduction device 1;

FIG. 4 is a diagram illustrating an example of a display screen of the information terminal 5;

FIG. 5 is a flowchart illustrating processing performed by an estimating unit 15;

FIG. 6 is a flowchart illustrating processing performed by the estimating unit 15;

FIG. 7 is a flowchart illustrating processing performed by the estimating unit 15;

FIG. 8 is a flowchart illustrating processing performed by the estimating unit 15;

FIG. 9 is a table illustrating association between a Kana (Japanese syllabary) string of related text and time information of related speech;

FIG. 10 is a diagram illustrating an example of a reproduction position tₚ of speech data after modification;

FIG. 11 is a diagram illustrating an example of a reproduction position tₚ of speech data after modification; and

FIG. 12 is a diagram illustrating an example of a display screen of the information terminal 5.

### DETAILED DESCRIPTION

According to an embodiment, a text reproduction device includes a reproducing unit, a first acquiring unit, a setting unit, a second acquiring unit, an estimating unit, and a modifying unit. The reproducing unit is configured to reproduce speech data. The first acquiring unit is configured to acquire text input by a user. The setting unit is configured to set a pause position delimiting the text in response to input data that is input by the user during reproduction of the speech data. The second acquiring unit is configured to acquire a reproduction position of the speech data being reproduced when the pause position is set. The estimating unit is configured to estimate a more accurate position in the speech data corresponding to the pause position by matching the text around the pause position with the speech data around the reproduction position. The modifying unit is configured to modify the reproduction position to the estimated more accurate position in the speech data, and set the pause position so that reproduction of the speech data can be started from the modified reproduction position when the pause position is designated by the user.

An embodiment of the present invention will be described in detail below with reference to the drawings.

In the present specification and the drawings, components that are the same as those described with reference to a previous drawing will be designated by the same reference numerals and detailed description thereof will not be repeated as appropriate.

A text reproduction device 1 according to an embodiment may be capable of being connected to an information terminal 5 such as a personal computer (PC) used by a user via wired or wireless connection or the Internet. The text reproduction device 1 is suitable for applications such as assisting a user in transcribing speech data of recorded utterance to text while listening to the speech data (transcription work).

When the user inputs a pause position that is a position at which text is delimited during input of the text while listening to speech data by using the information terminal 5, the text reproduction device 1 estimates a more accurate position (correct position) in the speech data corresponding to the pause position on the basis of text around the pause position and speech data around the speech data being reproduced when the pause position was input.

When the pause position is designated by the user, the text reproduction device 1 sets a cue position into the speech data so that the speech data can be reproduced from the estimated position in the speech data (cued and reproduced). As a result, the text reproduction device 1 can accurately cue up the speech.

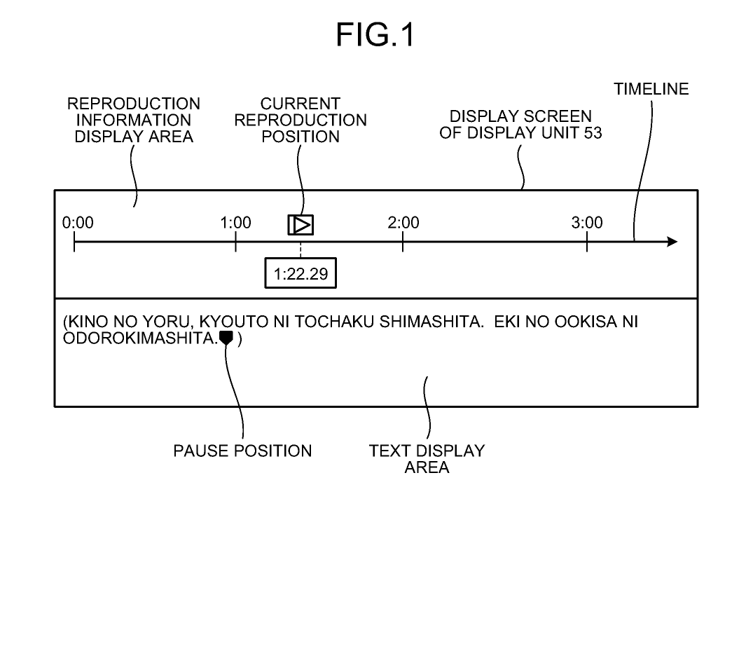

FIG. 1 is a diagram illustrating an example of a display screen of the information terminal 5. In this example, a reproduction information display area and a text display area are displayed on the display screen of a display unit 53.

The reproduction information display area is an area in which the reproduction position of the speech data is displayed. The reproduction position refers to time at which speech data is reproduced. In the example of FIG. 1, the reproduction position of the speech being currently reproduced is shown by a broken line on a timeline representing the length of the speech. The current reproduction position is “1 min 22.29 sec”.

In the text display area, text input so far by the user is displayed. While inputting the text, the user inputs a pause position at an appropriate position in the text. Details thereof will be described later. In FIG. 1, an example in which the user inputs a pause position after inputting a Japanese sentence “ [symbol] [symbol] [symbol] (EKI NO OOKISA NI ODOROKIMASHITA.)” is illustrated.

In the present embodiment, the user designates a pause position at a certain position in the text while performing “transcription work” of inputting text corresponding to speech while listening to the speech with the information terminal 5.

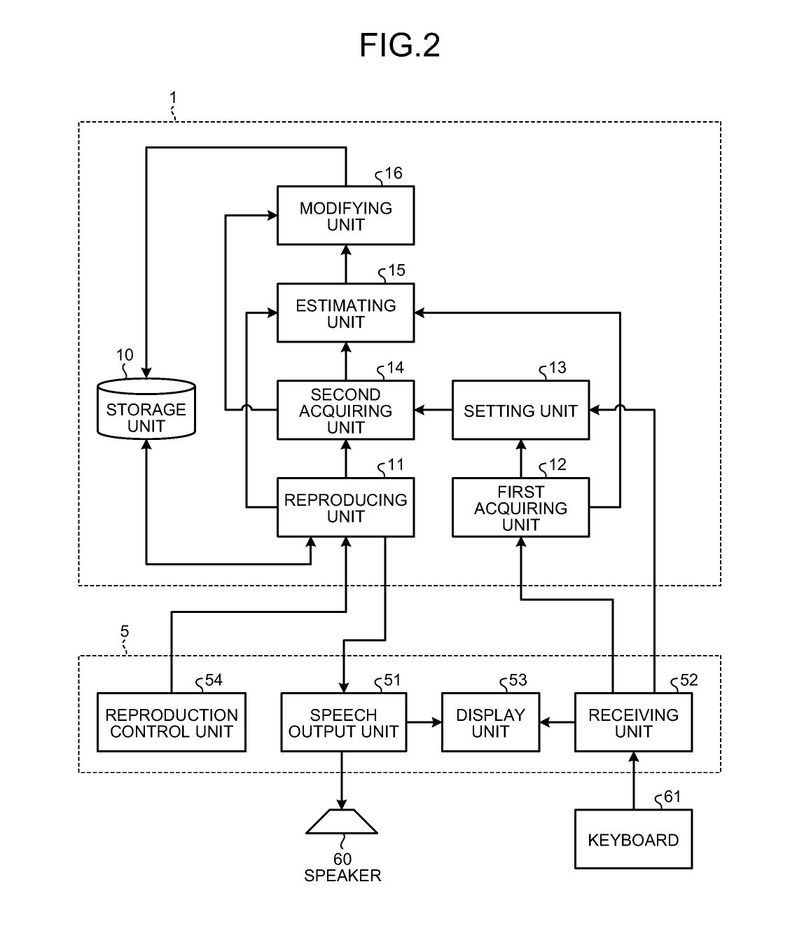

FIG. 2 is a block diagram illustrating the text reproduction device 1 and the information terminal 5. The text reproduction device 1 is connected to the information terminal 5. For example, the text reproduction device 1 may be a server on a network and the information terminal 5 may be a client terminal. The text reproduction device 1 includes a storage unit 10, a reproducing unit 11, a first acquiring unit 12, a setting unit 13, a second acquiring unit 14, an estimating unit 15, and a modifying unit 16. The information terminal 5 includes a speech output unit 51, a receiving unit 52, the display unit 53, and a reproduction control unit 54.

Description will be made on the information terminal 5.

The speech output unit 51 acquires speech data from the text reproduction device 1 and outputs speech via a speaker 60, a headphone (not illustrated), or the like. The speech output unit 51 supplies the speech data to the display unit 53.

The receiving unit 52 receives text input by the user. The receiving unit 52 also receives designation of a pause position input by the user. The receiving unit 52 may be connected to a keyboard 61 for a PC, for example. In this case, a shortcut key or the like for designating a pause position may be set in advance with the keyboard 61 for receiving the designation of a pause position made by the user. The receiving unit 52 supplies the input text to the display unit 53 and to the first acquiring unit 12 (described later) of the text reproduction device 1. The receiving unit 52 supplies the input pause position to the display unit 53 and to the setting unit 13 (described later) of the text reproduction device 1.

The display unit 53 has a display screen as illustrated in FIG. 1, displays the reproduction position of the speech data being currently reproduced in the reproduction information display area, and displays the text input so far and marks indicating the pause positions in the text display area.

The reproduction control unit 54 requests the reproducing unit 11 of the text reproduction device 1 to control the reproduction state of the speech data. Examples of the reproduction state of the speech data include play, stop, fast-rewind, fast-forward, cue and play, and the like.

The speech output unit 51, the receiving unit 52, and the reproduction control unit 54 may be realized by a central processing unit (CPU) included in the information terminal 5 and a memory used by the CPU.

Description will be made on the text reproduction device 1.

The storage unit 10 stores speech data and cue information. The cue information is information containing a pause position and a reproduction position of speech data associated with each other. The cue information is referred to by the reproducing unit 11 when cueing and reproduction is requested by the reproduction control unit 54 of the information terminal 5. Details thereof will be described later. The speech data may be uploaded by the user and stored in advance.

The reproducing unit 11 reads out and reproduces speech data from the storage unit 10 in response to a request from the reproduction control unit 54 of the information terminal 5 operated by the user. For cueing and reproduction, the reproducing unit 11 refers to the cue information in the storage unit 10 and obtains the reproduction position in the speech data corresponding to the pause position. The reproducing unit 11 supplies the reproduced speech data to the second acquiring unit 14, the estimating unit 15, and the speech output unit 51 of the information terminal 5.

The first acquiring unit 12 acquires text from the receiving unit 52 of the information terminal 5. The first acquiring unit 12 obtains the transcription position indicating the number of characters between a reference position in the text (the start position of the text, for example) and the text being currently written by the user. The first acquiring unit 12 supplies the acquired text to the setting unit 13, the estimating unit 15, and the modifying unit 16. The first acquiring unit 12 supplies the transcription position to the modifying unit 16.

The setting unit 13 sets the pause position acquired from the receiving unit 52 of the information terminal 5 into the supplied text. The setting unit 13 supplies information on the pause position to the second acquiring unit 14.

The second acquiring unit 14 acquires the reproduction position of the speech data being reproduced when the pause position was set. The second acquiring unit 14 obtains cue information containing the information on the pause position and the information on the reproduction position associated with each other. The second acquiring unit 14 obtains segments (utterance segments) of the speech data in which speech is uttered. The segments can be obtained by using known speech recognition technologies. The second acquiring unit 14 supplies the cue information to the estimating unit 15 and the modifying unit 16. The second acquiring unit 14 supplies the utterance segments to the estimating unit 15.

The estimating unit 15 matches the text around the pause position and the speech data around the reproduction position of the speech data by using the cue information and the utterance segments, and thus estimates the correct position in the speech data corresponding to the pause position. The transcription position is used for this process in the present embodiment (details will be described later). The estimating unit 15 supplies information on the correct position in the speech data to the modifying unit 16.

The modifying unit 16 modifies the reproduction position of the speech data in the cue information to the estimated correct position. The modifying unit 16 writes the cue information in which the reproduction position of the speech data is modified into the storage unit 10.

The reproducing unit 11, the first acquiring unit 12, the setting unit 13, the second acquiring unit 14, the estimating unit 15, and the modifying unit 16 may be realized by a CPU included in the text reproduction device 1 and a memory used by the CPU. The storage unit 10 may be realized by the memory used by the CPU and an auxiliary storage device.

The configurations of the text reproduction device 1 and the information terminal 5 have been described above.

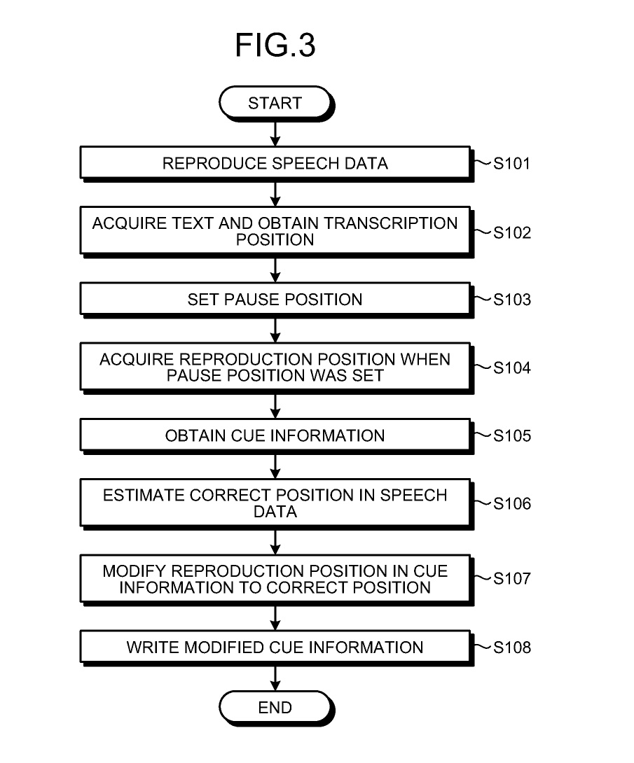

FIG. 3 is a flowchart illustrating processing performed by the text reproduction device 1

The reproducing unit 11 reads out and reproduces speech data from the storage unit 10 (S101).

The first acquiring unit 12 acquires text from the receiving unit 52 of the information terminal 5 (S102).

The setting unit 13 sets a pause position acquired from the receiving unit 52 of the information terminal 5 into the supplied text (S103). The second acquiring unit 14 acquires the reproduction position of the speech data being reproduced when the pause position was set (S104). The second acquiring unit 14 obtains cue information containing the information on the pause position and the information on the reproduction position associated with each other, and utterance segments (S105).

The estimating unit 15 uses the cue information and the utterance segments to match the text around the pause position and the speech data around the reproduction position of the speech data, and estimates the correct position in the speech data corresponding to the pause position (S106).

The modifying unit 16 modifies the reproduction position of the speech data in the cue information to the estimated correct position (S107). The modifying unit 16 writes the cue information in which the reproduction position of the speech data is modified into the storage unit 10 (S108). This concludes the processing performed by the text reproduction device 1.

The text reproduction device 1 will be described in detail below.

Description will first be made on the cue information. The cue information may be data expressed by Expression (1):

(id,Nₜₑ,tₚ,m)=(1,28,1:22.29,false) (1).

In the present embodiment, the cue information contains an identifier “id” identifying the cue information, a pause position “Nₜₛ” set by the setting unit 13, a reproduction position “tₚ” of the speech data acquired by the second acquiring unit 14 when the pause position is set, and modification information “m” indicating whether or not the modifying unit 16 has modified the reproduction position “tₚ” of the speech data, which are associated with one another. Note that the pause position “Nₜₛ” may represent the number of characters from a reference position in the text (the start position of the text, for example).

In the example of FIG. 1, Nₜ₃=28 because the pause position is the 28th character from the start position of the text, and m=false because the reproduction position “tₚ” has not been modified. Note that “true” represents that the reproduction position “tₚ” has been modified whereas “false” represents that the reproduction position “tₚ” has not been modified. The cue information in this case is thus expressed by Expression (1) when the identifier “id” is “1”.

Description will then be made on the utterance segments. The second acquiring unit 14 obtains the cue information and the utterance segments. The utterance segments may be expressed by Expression (2), for example:

[(t₁^{s},t₁^{e}), . . . ,(t₁^{s},t₁^{e}), . . . ,(t_{N}_{ₛₚ}^{s},t_{N}_{ₑₚ}^{e})] (2).

The example of Expression (2) expresses that Nₛₚ utterance segments are present in the speech data. The i-th utterance segment assumed to start at time t^{s}ᵢ and end at time t^{e}ᵢ is represented by (t^{s}ᵢ, t^{e}ᵢ).

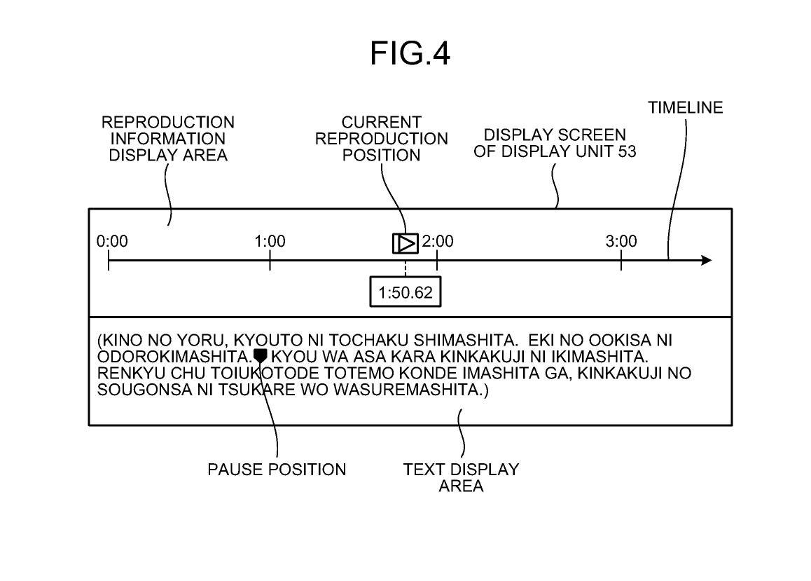

Description will then be made on the transcription position. The first acquiring unit 12 obtains the transcription position. FIG. 4 illustrates an example of the display unit 53 when the text is further input by the user than in FIG. 1. In FIG. 4, the user has input the text up to a Japanese sentence “ [symbol] (WASUREMASHITA.)”. The total number of characters at this point is 81. The transcription position is represented by N_{w} as in Expression (3):

N_{w}=81 (3).

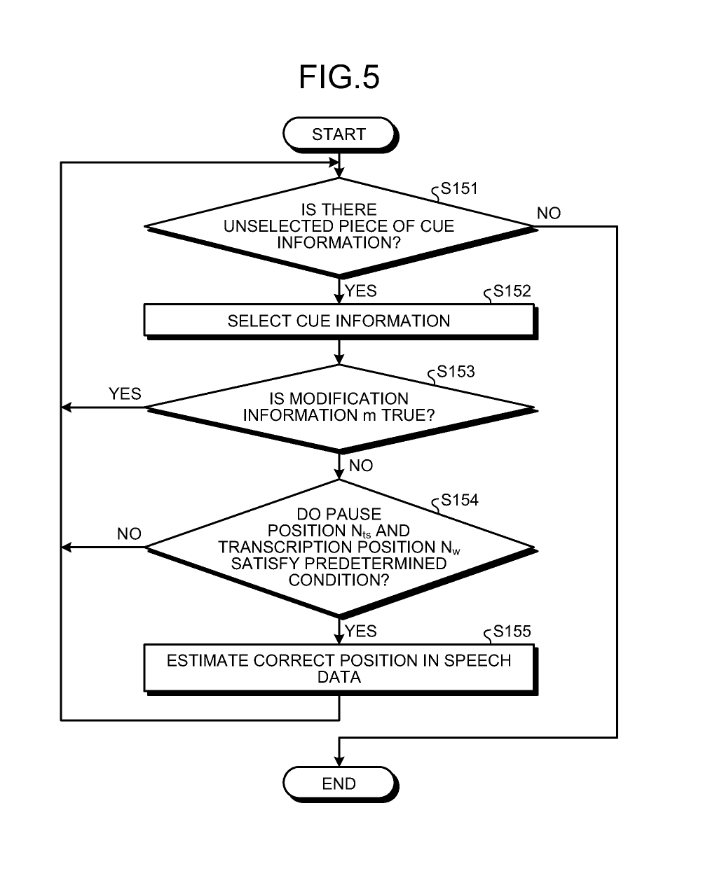

Description will then be made on processing performed by the estimating unit 15. FIG. 5 is a flowchart illustrating the processing performed by the estimating unit 15.

The estimating unit 15 determines whether or not there is an unselected piece of cue information among the pieces of cue information (S151). If there is no unselected piece of cue information (S151: NO), the estimating unit 15 terminates the processing.

If there is an unselected piece of cue information (S151: YES), the estimating unit 15 selects the unselected piece of cue information (S152).

The estimating unit 15 then determines whether or not the modification information “m” of the selected piece of cue information is true (S153). If the modification information “m” of the selected piece of cue information is true (S153: YES), the processing proceeds to step S151.

If the modification information “m” of the selected piece of cue information is not true (is false) (S153: NO), the estimating unit 15 determines whether or not the pause position “Nₜₛ” and the transcription position “N_{w}” satisfies a predetermined condition that will be described later (S154).

If the predetermined condition is not satisfied (S154: NO), the processing proceeds to step S151.

If the predetermined condition is satisfied (S154: YES), the estimating unit 15 estimates the correct position in the speech data (S155) and the processing proceeds to step S151.

The predetermined condition in the present embodiment is that “N_{offset} or more characters have been input from the pause position Nₜₛ and at least one punctuation mark is included in the newly input text”.

The predetermined condition can thus be expressed by Expression (4), for example:

N_{w}>Nₜₛ+N_{offset} and pnc(Nₜₛ,N_{w})=1 (4).

N_{offset} represents a preset number of characters, and pnc(Nₜₛ, N_{w}) represents a function for determining whether or not a punctuation mark is present between the Nₜₛ-th character and the N_{w}-th character and is expressed by Expression (5), for example:

$$pnc ( {N}_{ts} , {N}_{w} ) = \{ \begin{matrix}1 \text{:} & \begin{matrix}if punctuation mark is present in text \\ from Nts \text{-} th to Nw \text{-} th characters\end{matrix} \\ 0 \text{:} & \begin{matrix}if no punctuation mark is present in text \\ from Nts \text{-} th to Nw \text{-} th characters .\end{matrix}\end{matrix} \qquad ( 5 )$$

In Expression (5), pnc(Nₜₛ, N_{w}) refers to the Nₜₛ-th character and the N_{w}-th character of the text, outputs 1 if a punctuation mark is included between the Nₜₛ-th character and the N_{w}-th character, and outputs 0 otherwise.

Specifically, the estimating unit 15 determines that the predetermined condition is satisfied if the user further inputs N_{offset} or more characters of text from the pause position Nₜₛ in the cue information and if a punctuation mark is included in the newly input text. As a result of setting such a condition, processing in step S155 and subsequent steps can be performed in a state in which a certain number or more characters of text are further input.

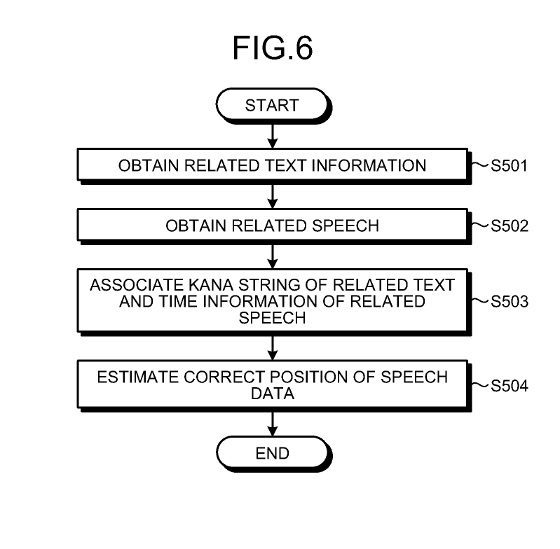

FIG. 6 is a flowchart illustrating detailed processing of step S155 of FIG. 5. The estimating unit 15 obtains related text information that will be described later (S501). The estimating unit 15 obtains related speech that will be described later (S502). The estimating unit 15 associates a Kana string of the related text with time information of the related speech (S503). The estimating unit 15 estimates the correct position in the speech data (S504).

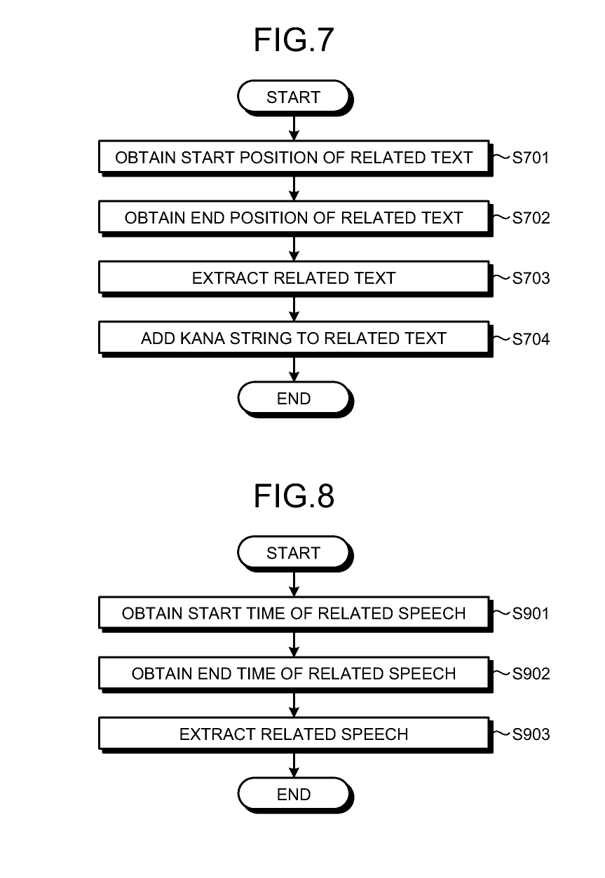

Step S501 will be described in detail. FIG. 7 is a flowchart illustrating detailed processing of step S501. The estimating unit 15 obtains the start position of the related text by using the pause position Nₜₛ (S701). The start position of the related text is a position of a punctuation mark immediately before the pause position or a position Nₙ_{_{—}}_{offset} characters before the pause position if there is no punctuation mark. For example, the start position Nₛ of the related text may be expressed by Expression (6):

Nₛ=max(└N_{pnc}┘,N−N_{n-offset}); Nₛ<Nₜₛ−1 (6).

In the expression, [N_{pnc}] represents a set of pieces of position information of punctuation marks and Nₙ_{_{—}}_{offset} represents a preset number of characters. In Expression (6), Nₛ is set to one of the two positions that is closer to the pause position Nₜₛ in the cue information, the two positions being the position of the punctuation mark that is before and the closest to (Nₜₛ−1) that is one character before the pause position and the position of the character Nₙ_{_{—}}_{offset} characters before the pause position N. If Nₙ_{_{—}}_{offset}=40, the value of Nₛ is set to the position of the period immediately before the Japanese sentence “ [symbol] [symbol] [symbol] [symbol] (EKI NO OOKISANI ODOROKIMASHITA)” and thus Nₛ=15 in the example of FIG. 4.

The estimating unit 15 obtains the end position of the related text by using the pause position Nₜₛ (S702).

The end position of the related text is a position of a punctuation mark immediately after the pause position Nₜₛ or a position Nₙ_{_{—}}_{offset} characters after the pause position Nₜₛ if there is no punctuation mark. For example, the end position Ne of the related text may be expressed by Expression (7):

Nₑ=min(└N_{pnc}┘,N+N_{n-offset});Nₑ>Nₜₛ (7).

Specifically, Nₑ is set to one of the two positions that is closer to the pause position Nₜₛ in the cue information, the two position being the position of the punctuation mark that is after and the closest to the pause position Nₜₛ and the position of the character that is Nₙ_{_{—}}_{offset} characters after the pause position Nₜₛ. If Nₙ_{_{—}}_{offset}=40, the value of Nₑ is set to the position of the period immediately after a Japanese sentence “ [symbol] [symbol] [symbol] [symbol] (KYOU WA ASA KARA KINKAKUJI NI IKIMASHITA)” and thus Nₑ=44 in the example of FIG. 4.

The estimating unit 15 extracts text between the start position Nₛ and the end position Nₑ as the related text (S703). The related text in the present example is the Japanese sentences “ [symbol] [symbol] [symbol] [symbol] [symbol] (EKI NO OOKISA NI ODOROKIMASHITA/KYOU WA ASA KARA KINKAKUJI NI IKIMASHITA)”. The part corresponding to the pause position in the cue information is represented by “/”.

The estimating unit 15 adds a Kana string to the related text (S704). The Kana string for the related text in the present example is “ [symbol] [symbol] [symbol] [symbol] [symbol] [symbol] (E KI NO O O KI SA NI O DO RO KI MA SHI TA/KYO U WA A SA KA RA KI N KA KU JI NI I KI MA SHI TA)” corresponding to the above Japanese sentences. The Kana characters may be added by using a known automatic Kana assigning technique based on a predetermined rule, for example.

Step S502 will be described in detail. FIG. 8 is a flowchart illustrating detailed processing of step S502. The estimating unit 15 uses the reproduction position tₚ of the speech data in the cue information to obtain the start time Ts of the related speech containing utterances before and after the reproduction position tₚ (S901). For example, the start time Ts of the related speech may be expressed by Expression (8):

Tₛ=max([tᵢ^{s}]); tᵢ^{s}<tₚ (8).

In the expression, [t^{s}ᵢ] represents a set of start times t^{s}ᵢ of the utterance segments. The start time of the utterance segment immediately before the reproduction time tₚ of the speech data is set to the start time Ts of the related speech by Expression (8).

The estimating unit 15 uses the reproduction position tₚ of the speech data in the cue information to obtain the end time Tₑ of the related speech containing utterances before and after the reproduction position tₚ (S902). For example, the end time Tₑ of the related speech may be expressed by Expression (9):

Tₑ=min([tᵢ^{e}]);tᵢ^{e}>tₚ (9).

In the expression, [t^{e}ᵢ] represents a set of end times t^{e}ᵢ of the utterance segments. The end time of the utterance segment immediately after the reproduction time tₚ of the speech data is set to the end time Tₑ of the related speech by Expression (9).

The estimating unit 15 extracts the speech of the segment between the start time Tₛ of the related speech and the end time Tₑ of the related text as the related speech (S903). For example, when Tₛ=1:03.00 and Tₑ=1:41.98 for tₚ=1:22.29, the related speech of 38.98 seconds is extracted.

Step S503 will be described in detail. The estimating unit 15 associates the Kana string of the related text with the time information of the related speech. The Kana string of the related text and the time information of the related speech may be associated by using a known speech alignment technique.

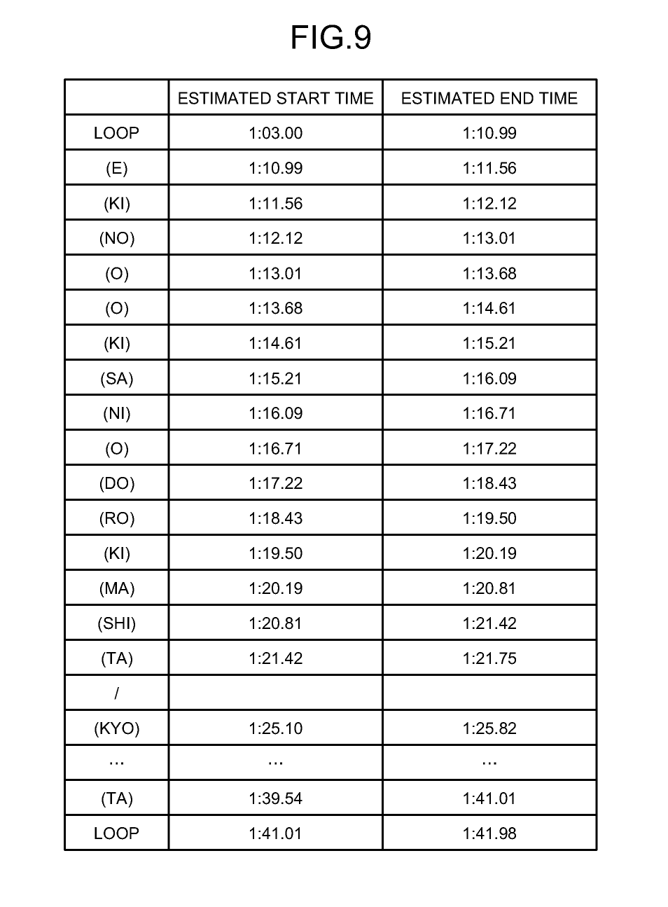

FIG. 9 is a table illustrating association between a Kana string of related text and time information of related speech. Loop represents a certain Kana string. Any speech other than that corresponding to the related text before and after the related speech can be associated as Loop by a known speech alignment technique. In the present embodiment, the start time and the end time of the last character “ [symbol] (TA)” of the Kana string of the related text “ [symbol] [symbol] [symbol] (E KI NO O O KI SA NI O DO RO KI MA SHI TA)” are estimated to be 1:20.81 and 1:21.42, respectively, and the start time and the end time of the first character (KYO) “ [symbol] (KYO)” of “ [symbol] (KYOU WA)” are estimated to be 1:25.10 and 1:25.82, respectively as a result of such association.

Step S504 will be described in detail. The estimating unit 15 estimates the estimated start position of the Kana character immediately after “/” of the Kana string of the related text to be the correct position of the speech data. The estimating unit 15 updates the modification information m of the cue information to true.

The modifying unit 16 modifies the reproduction position tₚ of the speech data in the cue information to the estimated correct position, and updates the modification information m to true. The updated cue information may be expressed by Expression (10), for example:

(id,Nₜₛ,tₚ,tₐ,m)=(1,28,1:22.29,1:25.82,true) (10).

In the present embodiment, the reproduction position tₚ of the speech data is modified from 1:22.29 that is the initial value to 1:25.10 that is the estimated start time of “ [symbol] (KYO)” immediately after “/”, and the modification information m is updated to true.

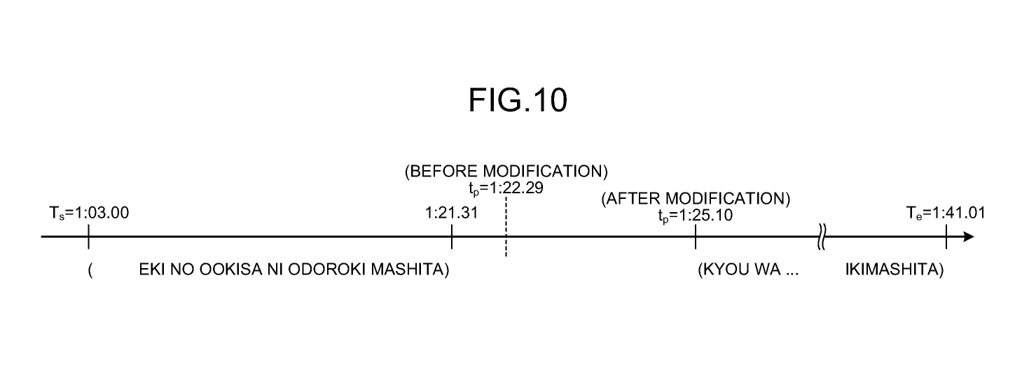

FIG. 10 is a diagram illustrating an example of the modified reproduction position tₚ of the speech data obtained according to the present embodiment. The horizontal axis represents time of the speech data. The characters in parentheses under the horizontal axis are the content of utterance. In FIG. 10, the content “ [symbol] [symbol] [symbol] (EKI NO OOKISANI ODOROKIMASHITA)” is uttered from time 1:03.00 to time 1:21.31.

The user inputs a pause position when the speech at tₚ=1:22.29 is being reproduced immediately after input of the text for “ [symbol] [symbol] (EKI NO OOKISANI ODOROKIMASHITA)” is completed. If the user requests cueing and reproduction before modifying the reproduction position tₚ of the speech data, reproduction of the speech will be cued to tₚ=1:22.29.

The time at which the next utterance “ [symbol] (KYOU WA)” actually starts is, however, 1:25.10, and thus a segment in which no utterance is contained is played for about three minutes after cueing and reproduction is started during which the user has to wait for the next speech to be started. According to the present embodiment, automatic modification of the reproduction position tₚ of the speech data in the cue information to 1:25.10 allows reproduction of the speech from the position desired by the user with a smaller waiting time.

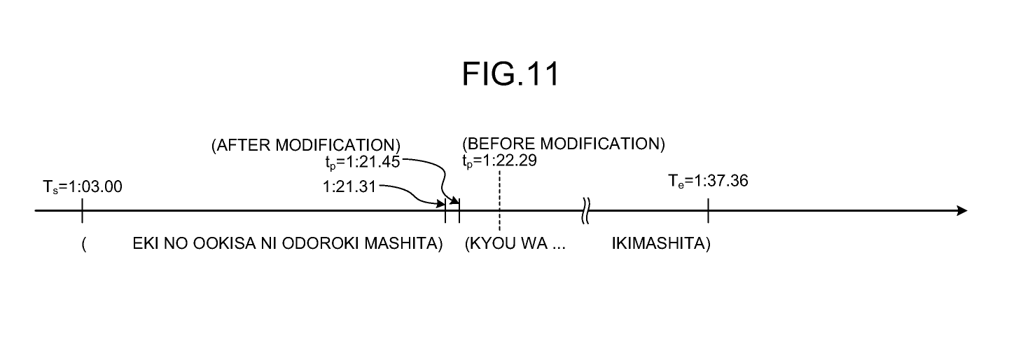

FIG. 11 is a diagram illustrating an example of the modified reproduction position tₚ of the speech data obtained according to the present embodiment.

In FIG. 11, speech with a content “ [symbol] [symbol] [symbol] (EKI NO OOKISA NI ODOROKIMASHITA)” ends at time 1:21.31, and after a short interval, utterance of the next speech “ [symbol] [symbol] (KYOU WA)” is started at time 1:21.45. The user has input a pause position immediately after input of text “ [symbol] [symbol] [symbol] (EKI NO OOKISA NI ODOROKIMASHITA)” is completed, but it is difficult to input the pause position at accurate timing because the interval between utterance segments is short.

In FIG. 11, the user has input the pause position at the reproduction position tₚ=1:22.29 of the speech data that is later than the start position of the speech “ [symbol] (KYOU WA)”. If the user requests cueing and reproduction before modifying the reproduction position tₚ of the speech data, reproduction of the speech will be cued to tₚ=1:22.29 and the user cannot listen to the speech of “ [symbol] [symbol] (KYOU WA)” from the start. According to the present embodiment, automatic modification of the reproduction position tₚ of the speech data in the cue information to 1:21.45 allows accurate reproduction of the speech from the position desired by the user.

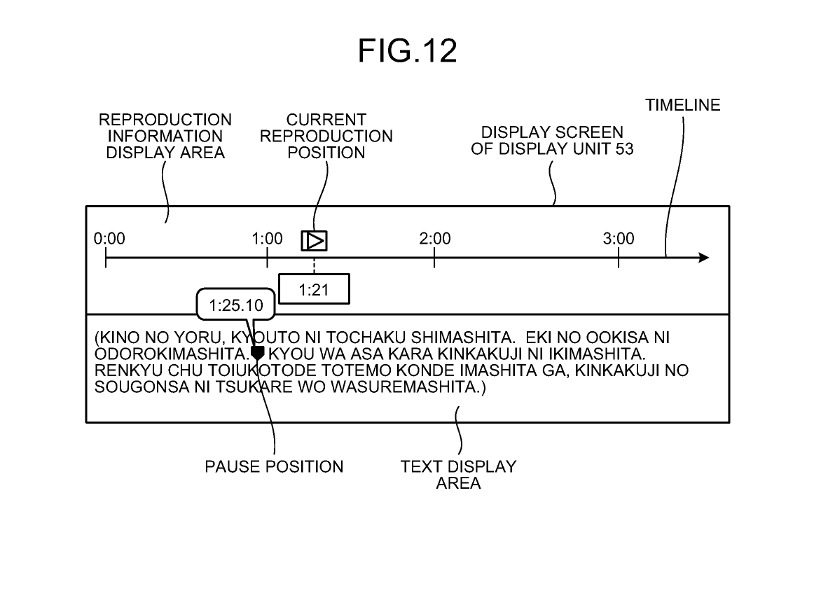

FIG. 12 illustrates an example of access to an icon of cue information in the text display area of the information terminal 5. Display of the pause position input by the user and the input text at the same time and enabling cueing of the speech with a click allows the user to intuitively access to the speech to which the user wants to listen again.

According to the present embodiment, speech can be accurately cued up.

The text reproduction device 1 according to the present embodiment can also be realized by using a general-purpose computer device in basic hardware, for example. Specifically, the reproducing unit 11, the first acquiring unit 12, the setting unit 13, the second acquiring unit 14, the estimating unit 15, and the modifying unit 16 can be realized by making a processor included in the computer device execute programs. In this case, the text reproduction device 1 may be realized by installing the programs in advance in the computer program or by storing the programs in a storage medium such as a CD-ROM or distributing the programs via a network and installing the programs in the computer device as necessary. Furthermore, the reproducing unit 11, the first acquiring unit 12, the setting unit 13, the second acquiring unit 14, the estimating unit 15, the modifying 16, and the storage unit 50 can be realized by using an internal or external memory of the computer device, a storage medium such as a hard disk, a CD-R, a CD-RW, a DVD-RAM, and a DVD-R, or the like as appropriate, as a computer program product. The same is applicable to the information terminal 5.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A text reproduction device comprising:
a reproducing unit configured to reproduce speech data;
a first acquiring unit configured to acquire text input by a user;
a setting unit configured to set a pause position delimiting the text in response to input data that is input by the user during reproduction of the speech data;
a second acquiring unit configured to acquire a reproduction position of the speech data being reproduced when the pause position is set;
an estimating unit configured to estimate a more accurate position in the speech data corresponding to the pause position by matching the text around the pause position with the speech data around the reproduction position; and
a modifying unit configured to
modify the reproduction position to the estimated more accurate position in the speech data, and
set the pause position so that reproduction of the speech data can be started from the modified reproduction position when the pause position is designated by the user.

2. The device according to claim 1, wherein the estimating unit is configured to estimate a start position of the speech data corresponding to the text immediately after the pause position to be the more accurate position in the speech data corresponding to the pause position.

3. The device according to claim 2, wherein
the second acquiring unit is configured to further obtain utterance segments that are segments of uttered speech in the speech data, and
the estimating unit is configured to match the text around the pause position and the speech data around the reproduction position by further using the utterance segments.

4. The device according to claim 3, wherein
the estimating unit is configured to
obtain utterance segments before and after the reproduction position of the speech data,
extract related speech corresponding to the utterance segments from the speech data,
extract related text from texts before and after the pause position, and
align the related speech with the related text to estimate time corresponding to the a text in the related text after the pause position to be the more accurate position in the speech data.

5. A text reproduction method comprising:
reproducing speech data;
acquiring text input by a user;
setting a pause position delimiting the text in response to input data that is input by the user during reproduction of the speech data;
acquiring a reproduction position of the speech data being reproduced when the pause position is set;
estimating a more accurate position in the speech data corresponding to the pause position by matching the text around the pause position with the speech data around the reproduction position;
modifying the reproduction position to the estimated more accurate position in the speech data; and
setting the pause position so that reproduction of the speech data can be started from the modified reproduction position when the pause position is designated by the user.

6. A computer program product comprising a computer-readable medium containing a program executed by a computer, the program causing the computer to execute:
reproducing speech data;
acquiring text input by a user;
setting a pause position delimiting the text in response to input data that is input by the user during reproduction of the speech data;
acquiring a reproduction position of the speech data being reproduced when the pause position is set;
estimating a more accurate position in the speech data corresponding to the pause position by matching the text around the pause position with the speech data around the reproduction position;
modifying the reproduction position to the estimated more accurate position in the speech data; and
setting the pause position so that reproduction of the speech data can be started from the modified reproduction position when the pause position is designated by the user.
